(19) United States
(12) Patent Application Publication
(10) Pub. No.: US 2004/0215352 A1
(43) Pub. Date: Oct. 28, 2004

(54) Controlled device in network apparatus, controlling device, and its control method

(76) Inventors: Kenji Muraki, Osaka-shi (JP); Naoki Ejima, Hirakata-shi (JP)

Correspondence Address: Parkhurst & Wendel, Suite 210, 1421 Prince Street, Alexandria, VA, 22314-2805, US

(21) Appl. No.: 10/148,260

(22) PCT Filed: Oct. 4, 2001
(86) PCT No.: PCT/JP01/08779

(30) Foreign Application Priority Data
Oct. 25, 2000 (JP) 2000-324783

(51) Int. Cl. G05B 15/00; G05B 11/01

(52) U.S. Cl. 700/11; 700/83

(57) ABSTRACT

A controlled device (103) containing a plurality of controlled objects (functional units) includes selection means (109) that allows a user to select a functional unit to be controlled. If a command including no information specifying which functional unit in the controlled device is to be controlled is received, the controlled device (103) uses the selection means (109) to allow the user to select the functional unit to be controlled and determines the selected functional unit as an object to be controlled in the controlled device (103) so that the unit intended by the user is selected as the unit to be controlled.

### TECHNICAL FIELD

The present invention relates to a control device and a controlled device for transmitting and receiving control information through a digital interface, and to a method for controlling them.

### BACKGROUND ART

In recent years, the IEEE (The Institute of Electrical and Electronics Engineers, Inc.) 1394 technology has received attention. The IEEE 1394 technology can be used in place of conventional SCSI (Small Computer System Interface) computer data transmission and, in addition, can be used for transmission of audio and visual data. This is because the IEEE 1394 specification defines two communication methods: isochronous communication and asynchronous communication.

The asynchronous communication is used for transmission of data that does not require real-time transmission, such as device control information and computer data files.

The isochronous communication, on the other hand, can be used for transmission of data, such as audio-visual data, that requires real-time transmission. In the isochronous communication, a band required for transmitting data is obtained before starting the transmission. Then the band is used to transmit the data. This ensures real-time data transmission.

Various IEEE 1394 transfer protocols have been proposed. One is known as the AV-protocol. The AV-protocol is standardized as IEC (International Electrotechnical Commission) 61883. IEC 61883 specifies a method for sending and receiving instructions provided to devices using asynchronous communication, a method for sending and receiving audiovisual data using isochronous communication, and other methods.

One method for transmitting instructions to devices through asynchronous communication is the Function Control Protocol (hereinafter abbreviated to “FCP”) defined in IEC 61883. In addition, control methods common to various devices using FCP and controlling methods specific to particular devices using FCP are defined by 1394 Trade Association (herein after called “1394 TA”).

A common control method defined is AV/C Digital Interface Command Set General Specification Rev.3.0 (hereinafter called “AV/C General), for example. Device-specific control methods are standardized for individual types of devices. As such a device-specific method, the PATH THROUGH command (hereinafter called “pass-through”) defined by the AV/C Panel subunit has been proposed. These specifications are described in the Web page of 1394 TA (http://1394ta.org/).

The pass-through mode will be further described below.

In the AV protocol, one package is called “unit” and individual functional units in the package is called “subunit.” For example, a unit in which one CD player is installed has one disk subunit. A unit in which a CD player and an FM tuner are installed has a disk subunit and a tuner subunit. These subunits are defined in AV/C General along with subunit_type codes.

A panel subunit is used for controlling a controlled device from an external control device in an operating environment, such as the operation panel of a device. In pass-through mode, a pass-through command is defined to transparently provide a user operation from a control device to a controlled device. That is, an operating environment such as an infrared remote controller is provided.

A method for sending and receiving control information by using the pass-through will be described below with reference to the accompanying drawings. Timing of packet transmission over an IEEE 1394 bus and device control using path-through (device configuration, transmission packet structure, and device control procedure using path-through) will be describe in that order.

FIG. 6 shows the timing of packet transmission over an IEEE 1394 bus.

Symbol “CS” in FIG. 6 indicates a cycle-start packet, “ISO” indicates an isochronous packet used in isochronous communication, ASy indicates an asynchronous packet used in asynchronous communication.

First, timing of transmitting the isochronous packet in an isochronous cycle (125 μs) will be described.

Before starting isochronous transmission, a node called “isochronous bus manager” coupled onto the 1394 bus allocates a bandwidth for the transmission to a node that wants to perform isochronous communication. The bandwidth available for isochronous communication is 100 μs per isochronous cycle (125 μs).

After the completion of the transmission bandwidth allocation, data transmission starts. In IEEE 1394, a cycle-master node among nodes coupled onto the bus issues a cycle-start packet (CS) in each isochronous cycle. A node attempting to send an asynchronous packet (ISO) following the cycle-start packet starts a transmission request operation, acquires the bus, and then sends the isochronous packet. After an idle period called isochronous gap following each isochronous packet transmission elapses, another node initiates a transmission request operation in order to send an isochronous packet, acquires the bus, and then sends the packet. After all isochronous packets are transmitted, an idle period called subaction gap follows. Then, a node attempting to send an asynchronous packet (Asy) initiates an asynchronous transmission request operation, acquires the bus, and then sends the asynchronous packet. Because a subaction gap time is greater than an isochronous gap time, a higher priority is given to the isochronous packet, thereby ensuring constant transfer of isochronous packets.

Asynchronous packet (Asy) transmission will described below.

A node attempting to send an asynchronous packet can send the packet only once in a period called fairness interval. This mechanism allows every node to equally-perform asynchronous transmission. That is, each node has a register called “arb_enable.” This register is set by an idle-period called an arbitration-reset gap, which is greater than a subaction gap. A node whose arb_enable register is set can make an asynchronous transmission request. After the completion of the asynchronous transmission, the arb_enable register is cleared. In this way, nodes whose arb_enable register is set perform asynchronous transmission one after another. After all nodes that want to perform asynchronous communication complete asynchronous communication and the subsequent arbitration gap elapses, no bus acquisition occurs but an arbitration-reset gap occurs, then the next fairness interval follows. In this new fairness interval, arb enable of all the nodes is reset and the nodes again start asynchronous transmission in sequence. The number of nodes that request asynchronous transmission and the amount of data transmitted vary among fairness intervals, and, consequently, the amounts of time vary from fairness interval to fairness interval.

Device control with path-through will be described below.

FIG. 7 shows an exemplary arrangement in which device control by path-through is performed. A specific example may be a combination of television and a DVD (Digital Versatile Disc) player connected to it over a network. In this case, the television set is a control device and the DVD player is a controlled device. A remote controller associated with the television set is a user interface.

Reference number 1101 indicates a user interface, which may be a control panel or remote controller, for example, of a device. Reference number 1102 indicates a control device, 1103 indicates a controlled device, 1104 indicates an IEEE 1394 bus interconnecting the control device 1102 and the controlled device 1103, and 1105 indicates a video signal line transmitting a video signal from the controlled device 1103 to the control device 1102.

The control device 1102 includes control information sending means 1106 for providing control information onto the IEEE 1394 bus according to a signal from the user interface 1101 and display means 1107 for displaying a video signal provided from the controlled device 1103.

The controlled device 1103 includes control information input means 1108 to which control information is inputted from the IEEE 1394 bus 1104, media reproduction means 1109 for reproducing a medium according to control provided from the control information input means 1108, and display information generation means 1110 for superimposing a display according to the control information provided from control information input means on a reproduction signal provided from the media reproduction means 1109.

The media information reproduction means 1109 may be a DBD drive, for example. A video signal recorded and subpicture information for navigation are reproduced from the DVD. The subpicture information is used to selectively display or highlight particular information depending on control information provided from the control information input means 1108. This will be detailed later.

A packet structure for transmitting device control information will be described below.

FIG. 8a shows a structure of a control information packet issued by the control information sending means 1106.

The packet consists of an asynchronous packet header, FCP data, and data CRC. The asynchronous packet header is specified in the IEEE 1394-1995 specification. The asynchronous packet header is 20 bytes long and contains a destination node ID (destination_ID), a destination address offset (destination_offset), a source node ID (source_ID) a data length (data_length), a header CRC, and other data. The destination node ID specifies the node ID of a device connected to a 1394 bus.

The destination address offset specifies an address at which data is written. When FCP data is transmitted, the destination address offset represents an FCP command register (0×FFFF F000 0B00).

The CTS (Command/Transaction Set) field of the FCP data is a code indicating the type of a command that follows. The CTS of an AV/C command defined in AV/C General is 0h. A ctype field indicates a command type such as a control command and a get status command. A subunit type field indicates the type of a subunit that is the destination of the command. A subunit ID field is an identifier identifying a subunit of the same type in the unit. The subunit type field and subunit ID field specify the subunit that is the destination of the command. When a pass-through command is used, a panel subunit is specified as the destination of the command. In FIG. 7, the control information input means 1108 represents the command receiving function of the panel subunit. Because only one panel subunit can exist in a node, the subunit-ID is 0. An opcode field defines an operation to be performed or a status to be obtained. Operand [x] fields specify parameters. The values of the parameters depend on the ctype field, opcode field, operand[x] field, and other fields.

An IEEE 1394 packet is constructed in units of 4 bytes. Therefore, if the FCP flame including the last operand[x] field is not a multiple of 4, 00h” is appended (zero padding) to make it a multiple of 4.

FIG. 8 shows a pass-through command.

Following the opcode field, there are a state flag field (1 bit), operation id field (7 bits), operation data field length filed, and operation data field.

The state flag field indicates a state, such as a push or release of a button. The operation id field specifies an operation to be performed by the controlled device. Typical operations specified include a GUI (Graphical User Interface) operation, menu operation, and specification of a device operation and a number. GUI operations may include a cursor movement (by four-direction arrow keys) or selection of the current cursor position, for example. Menu operations may be operations on basic menu, content menu, and setting menu. Device operation specifications may be playback, stop, and pause. The operation data field length filed indicates the length of the operation data field in bytes. If there is no operation data field, it indicates “0.” The operation data field contains additional data, if any, which is required depending on the content of the operation-id field.

A procedure for device control performed in the arrangement in FIG. 7 by using the control information transmission packet shown in FIG. 8 will be described below. For example, seven items of title information-are contained in a subpicture for selecting a DVD content and sent from the media reproduction means 1109 to the display information generation means 1110, as shown in FIG. 9. One of the sent title information items is highlighted according to control information (cursor-upward-movement control information, cursor-downward-movement control information, or other control information). When control information (selection control information) is inputted while a desired title is highlighted, the display of the title information ends and reproduction of a contents corresponding to the selection is started in the media reproduction means 1109. The display information generation means 1110 continues outputting the title information (including highlighting according to cursor movement) onto the video signal line 1105 during the above-described content selection operation. Therefore, the display means 1107 of the control device 1102 presents a screen as shown in FIG. 9 to a user.

However, the prior-art method described above has the problem that, if a plurality of elements (functional units) to be controlled is contained in the controlled device, the control device cannot specify which of the functional units should be controlled.

That is, if there is two media reproduction means in FIG. 7, for example, which of the media reproduction means should be controlled cannot be specified because the panel subunit is specified as the destination of the pass-through command shown in FIG. 8.

### DISCLOSURE OF INVENTION

The present invention solves the problem with the prior art. It is an object of the present invention to provide a controlled device, a control device, and a control method thereof that allow one of a plurality of controlled elements in the controlled device to be selected.

To achieve the object of the present invention, there is provided according to the claim 1 of the present invention a controlled device containing a plurality of functional units and connected in use to a control device through a digital interface of a network, the controlled device comprising selection means for selecting a functional unit to be controlled based on an instruction from the control device, storing the selection, and determining the stored functional unit as an object to be controlled in response to detecting the reception of a control command including no information specifying an object to be controlled from the control device.

The controlled device as set forth in claim 2 of the present invention is characterized in that the selection means in the controlled device according to the claim 1 is arranged so as to select a functional unit to be controlled based on an instruction from the control device and store the selection when no functional unit to be controlled is determined. The controlled device as set forth in claim 3 of the present invention is characterized in that the selection means in the controlled device according to claim 1 detects the reception of a control command including no information specifying which functional unit is to be controlled and selects a functional unit stored as a default value when no functional unit to be controlled is determined.

According to claim 4 of the present invention, there is provided a control device connected in use through a digital interface of a network to a controlled device containing a plurality of functional units, the control device comprising selection means for allowing a user to select a functional unit to be controlled, causing the result of the selection to be stored in the controlled device, and sending a control command including no information specifying which functional unit in the controlled device is to be controlled.

According to Claim 5 of the present invention, there is provided a controlled device containing a plurality of functional units and being connected in use to the control device as set forth in claim 4 through a digital interface of a network, the controlled device comprising: allocation means for storing the result of selection of a functional unit to be controlled, the result being sent from the control device, and, in response to detecting the reception of a control command including no information specifying which functional unit is to be controlled, determining the selected functional unit as an object to be controlled.

According to claim 6 of the present invention, there is provided a controlled device containing a plurality of functional unit and connected in use to a control device through a digital interface of a network, comprising: switching means for selecting a functional unit to be controlled on an instruction from the control device, storing the selection, and outputting an output signal of the selected functional unit; and allocation means for allocating a instruction from the control device to the plurality of functional units, and, in response to detecting the reception of a control command including no information specifying which functional unit is to be controlled, causing the received command to be applied to the functional unit from which the switching means is outputting the output signal.

### BRIEF DESCRIPTION OF DRAWINGS

FIG. 1 is a block diagram of a control device and a controlled device according to a first embodiment of the present invention;

FIG. 2a shows an example of a media reproduction means selection screen according to the first embodiment and FIG. 2b shows another example of the media reproduction means selection screen;

FIG. 3 is a block diagram of a control device and a controlled device according to a second embodiment of the present invention;

FIG. 4 is a block diagram of a control device and a controlled device according to a third embodiment of the present invention;

FIG. 5 shows a content of the connect command;

FIG. 6 is a timing diagram for packet transmission over an IEEE 1394 bus;

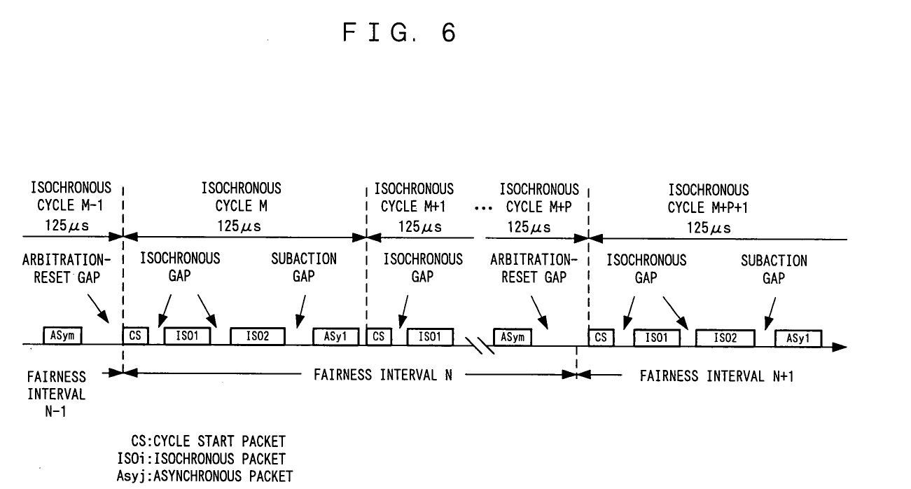

FIG. 7 is a block diagram of an arrangement in which device control with a pass-through command is performed;

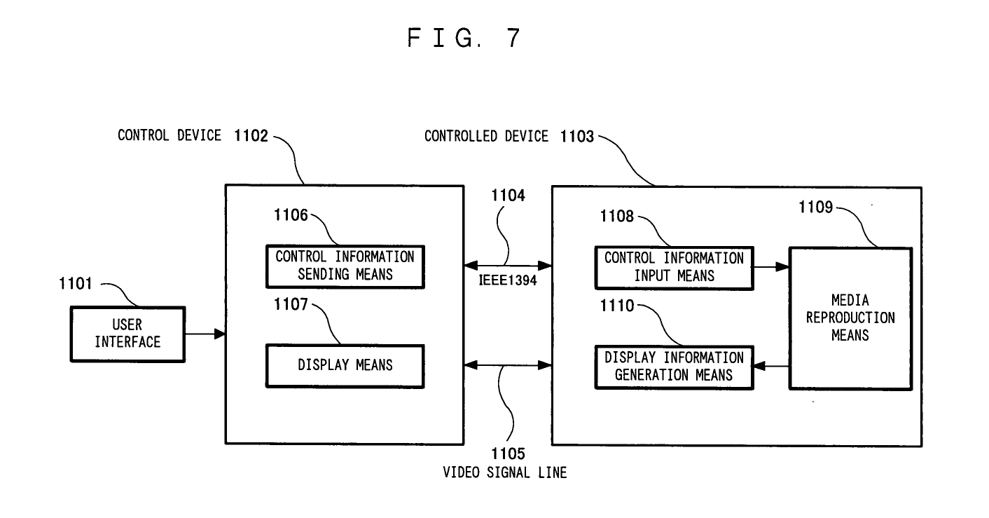

FIG. 8a shows a structure of a control information packet issued by a control information sending means 1106, and FIG. 8b shows contents of a pass-through command; and

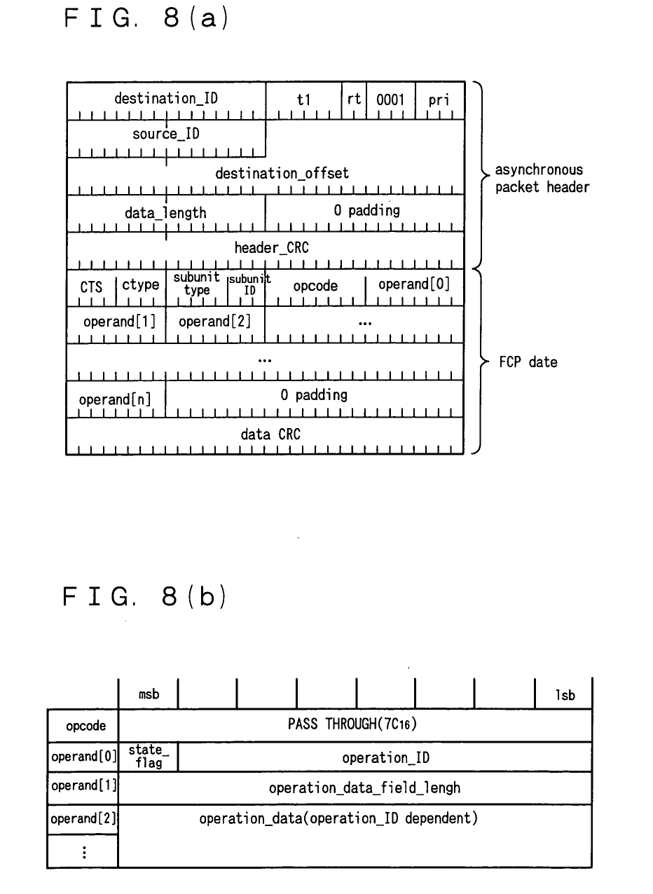

FIG. 9 shows a subpicture for selecting a content of a DVD.

### BEST MODE FOR CARRYING OUT THE INVENTION

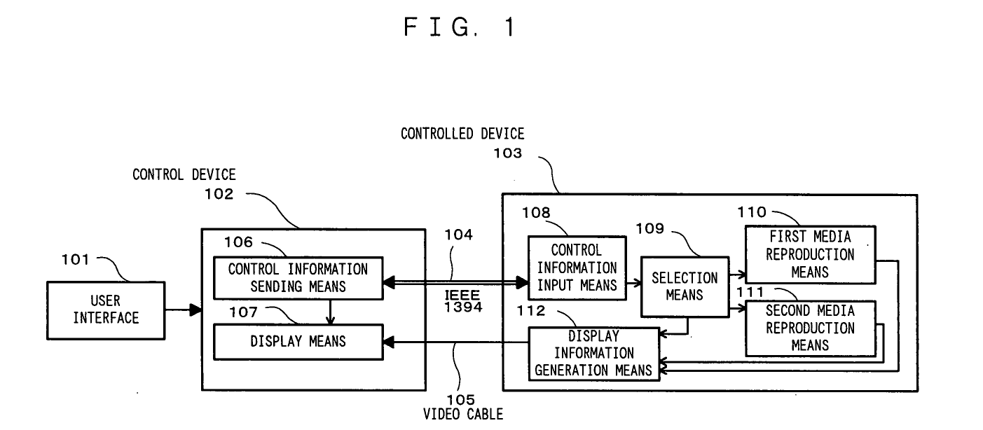

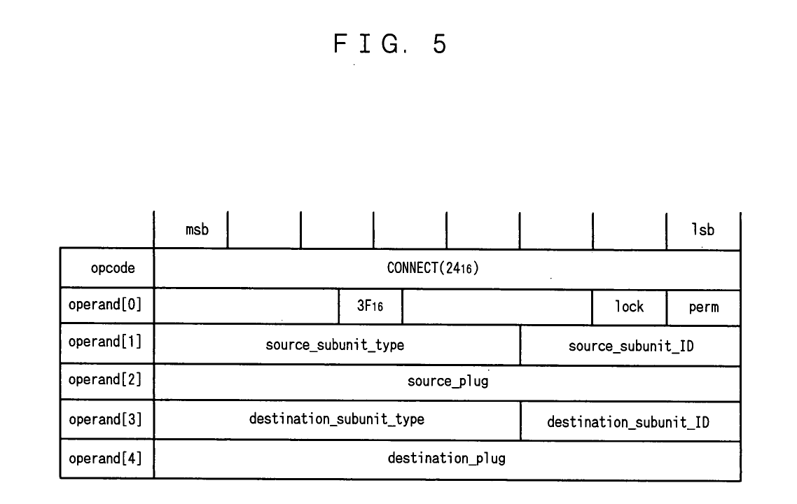

Embodiments of the present invention will be described below with respect to FIGS. 1 and 5.

First Embodiment

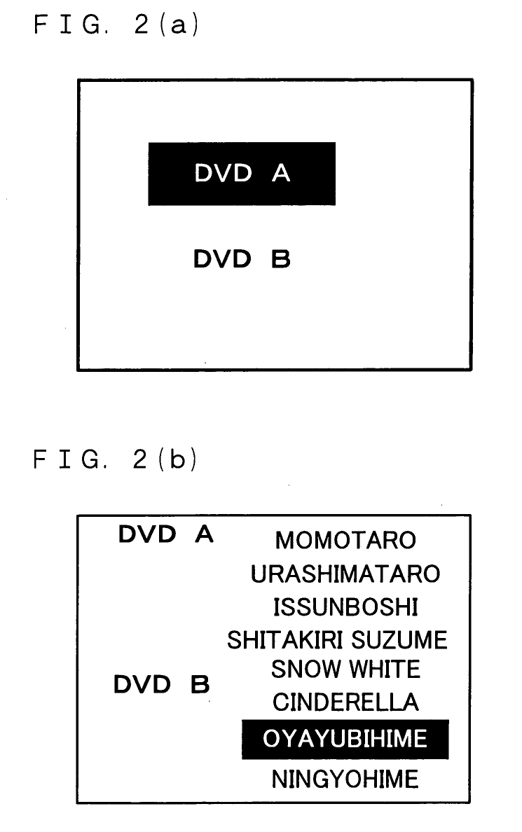

FIGS. 1 and 2 show a first embodiment.

It is assumed that an interface uses an IEEE 1394 pass-through command.

Reference number 101 indicates the user interface, which may be a control panel or remote controller of a device. Reference number 102 indicates a control device, 103 indicates a controlled device, 104 indicates an IEEE 1394 bus interconnecting the control device 102 and the controlled device 103, and reference number 105 indicates a video signal line for transmitting a video signal from the controlled device 103 to the control device 102. A specific example may be a combination of a television set and a DVD player connected, to it over a network. In this case, the television set is the control device, the DVD player is the controlled device, and a remote controller associated with the television set is the user interface.

The control device 102 includes control information sending means 106 for providing control information onto the IEEE 1394 bus according to a signal provided from the user interface 101 and a display means 107 for displaying a video signal provided from the controlling information sending means 106 and/or the controlled device 103. The information provided from the control information sending means 106 may be superimposed as text or GUI on a video signal provided from the controlled device 103 according to control from the user interface 101 or other elements. It is also possible to display one of an output from the control information sending means 106 and an output from the controlled device 103.

The controlled device 103 includes control information input means 108 for inputting control information from the IEEE 1394 bus, a selection means 109 for generating a user interface signal for the user to select an element to which the control information provided from the control information input means 108 is applied and for assigning control information to an appropriate functional unit according to the result of the selection by the user first media reproduction means 110 for reproducing a medium according to a control from the selection means 109, second-media reproduction means 111 for reproducing a medium according to a control from the selection means 109, and display information generation means 112 for superimposing a display on a reproduction signal provided from the first and second media reproduction means 110 and 111 according to selection information from the selection means 109 and the control information from the control information input means 108.

The media information reproduction means may be a DVD drive, for example. In this embodiment, the media reproduction means is a functional unit.

Because no standard for outputting DVD video signal onto IEEE 1394 buses has been developed yet, the video signal line 105 is used in addition to the IEEE 1394. However, it may be transmitted over the IEEE 1394 once a DVD video signal format for IEEE 1394 buses is established.

A procedure for performing device control in the arrangement shown in FIG. 1 will be described below.

First, a procedure from initialization of the bus until the user selects a device (unit) to be controlled will be described.

When a device is connected to the IEEE 1394 bus, a node ID is automatically assigned to each device (unit) connected to the bus during the initialization. After the completion of the initialization, a device controlling other devices as a controller identifies the devices connected to the bus.

That is, the control device 102 uses the control information sending means 106 to issue a UNIT INFO command defined in the AV/C General. In response to this command, the devices connected to the bus select predetermined, typical one of functional units (subunit types) contained in the devices and return it to the control unit 102. When the control device 102 sends a SUBUNIT INFO command, all subunits and the number of the subunits in the unit are returned. The control device 102 can read configuration ROM (not shown) of each unit to know the manufacturer of each device and other information.

The control device 102 uses the display means 107 to present the information to the user. The user uses the user interface 101 to select a unit to control. In this example, it is assumed that the user-selects controlled device 103.

The user knows that the controlled device 103 has a panel subunit. Therefore, he or she sets the control device 102 so as to display a video signal for the controlled device 103 on the display means 107. In the first-embodiment, the video signal is provided through the video signal line 105 and the user uses a video switching function of the user interface 101 to change the input to the display means 107.

The video signal line 105 may be automatically selected as the input to the display means 107 when it is identified that the controlled device 103 has a panel subunit. If a device made by the same manufacturer as that of a previous device is connected, then its wiring has been made as specified its instruction manual and the wiring can be automatically selected, thereby saving the user the trouble.

A procedure for selecting an element to be controlled will be described below.

The controlled device 103 outputs information required for the selection means 109 to generate a screen on which one of the first and second media reproduction means 110 and 111 can be selected, as shown in FIG. 2a. This screen-information is displayed on the display means 107 as shown in FIG. 2a through the display information generation means 112.

In FIG. 2a, “DVD A” is highlighted to indicate that the first media reproduction means 110 is selected. The user operates the user interface 101. The control information sending means 106 issues a pass-through command according to the user's operation.

In particular, the control information sending means 106 issues a pass-through command of an operation. ID corresponding to the up-arrow or down-arrow key. The control information input means 108 receives the pass-through command and transfers control information to the selection means 109. The selection means 109 performs a GUI operation according to the control information to move the highlight. When the control information sending means 106 issues a pass-through command of an operation ID corresponding to “confirmation” performed by a user operation, the selection means 109 stores, as an object to be controlled, one of the first and second media reproduction means 110 and 111 that is highlighted at the time. Thus, the object to be controlled in the controlled device 103 is determined.

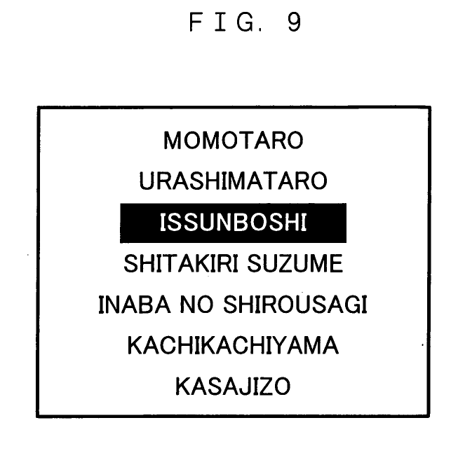

Then, selected one of the first and second media reproduction means 110 and 111 outputs screen information for selecting a content, as shown in FIG. 9. The screen information is displayed as shown in FIG. 9 on the display means 107 through the display information generation means 112.

The user operates the user interface 101 to select a content. Control information in the pass-through command issued by the control information sending means 106 is transferred to one of the first and second media reproduction means 110 and 111, which is stored in the selection means 109, and screen information for content selection is updated and the content is selected.

The pass-through command can be specified by any other device operations, besides the GUI operation. If a pass-through command of an operation id for specifying a device operation such as a stop or a pause is sent to the controlled device 103 while a content is selected and being reproduced, it is transferred to one of the first and second media reproduction means 110 and 111 stored in the selection means 109 and the media reproduction is controlled, as with the GUI operation.

If a pass-through command of an operation id specifying a device operation is sent to the controlled device 103 before a media reproduction means is selected, media reproduction means stored in the device previously as a default value may be selected as the object to be controlled.

If no medium is loaded in the media reproduction means stored in the, device as the default value, it may be determined whether the other media reproduction means contains a medium and, if it contains one, it may be selected as means to be controlled. The media reproduction means selected in this way is stored in the selection means 109 and becomes the means to be controlled subsequently.

If a pass-through command of an operation id of a operation on a menu (for example a setup menu defined in the Panel Subunit Specification) is sent to the controlled device 103, the media reproduction means selection screen shown in FIG. 2a is displayed so that a functional unit to be controlled can readily be changed.

Thus, even if selection of a functional unit to be controlled has been confirmed, another functional unit can be re-selected.

While the screen for selecting a functional unit to be controlled is shown in FIG. 2a, functional units and their contents may be presented at a time as shown in FIG. 2b. In that case, the user may select a functional unit or a content. If the user selects a content, the functional unit that contains that content is selected, a pass-through command of an operation ID corresponding to “Confirmation” is sent from the control device 102 to the controlled device 103, functional unit selection information is provided and the content is reproduced.

While the IEEE 1394 digital interface is used in this embodiment, any other digital interfaces can be used. For example, the embodiment can be applied to device control using Bluetooth.

According to the first embodiment as described, above, the controlled device 103 has the selection means 109 allowing a user to select a functional unit to be controlled by using the display-means. The user selects a functional-unit to be controlled and the result of the selection is stored. Thus, the first embodiment provides the advantage that a command specifying no functional unit that actually performs an operation in the controlled device can be used and yet the command can be applied to a functional unit intended by the user.

Second Embodiment

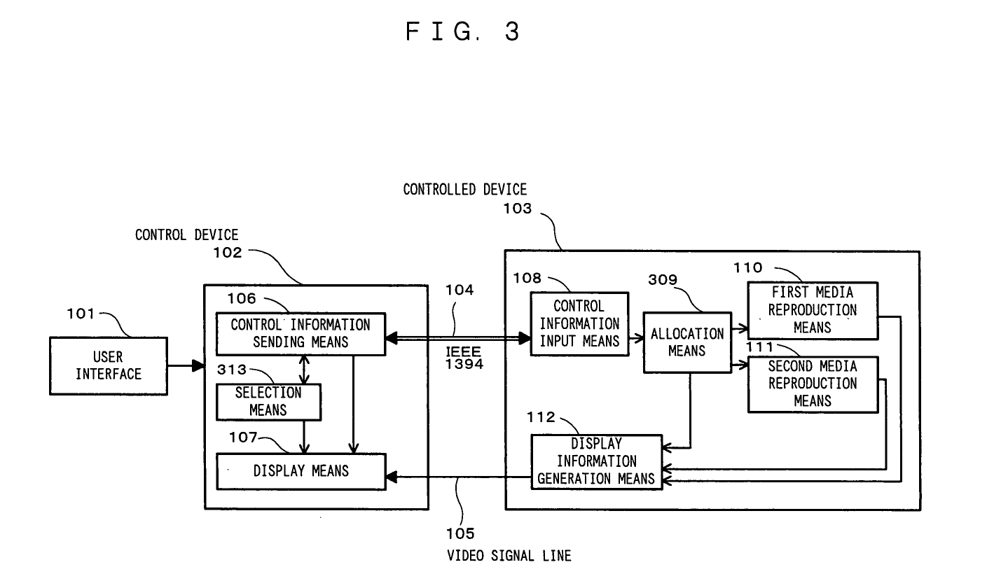

FIG. 3 shows a second embodiment of the present invention. The same elements as those in FIG. 1 are labeled with the same numbers and will be described using those same numbers.

It is assumed that an IEEE 1394 interface and a pass-through command are used for device control.

Reference number 101 indicates a user interface, which may be a remote controller or control panel of a device, for example. Reference number 102 indicates a control device, 103 indicates a controlled device, 104 indicates an IEEE 1394 bus interconnecting the control device 102 and the controlled device 103, and 105 indicates a video signal line for transmitting a video signal from the controlled device 103 to the control device 102.

The control device 102 includes control information sending means 106 for providing control information onto the IEEE 1394 bus 104 according to a signal from the user interface 101 and selection means 313, and the selection means 313 that exchanges information with the user interface 101 and control information sending means 106 and provides the result to display means 107, and the display means 107 for displaying video signals provided from the controlled device 103 and the selection means 313 and further from the control information sending means 106.

Information provided from the control information sending means 106 may be superimposed as text or a GUI on video signals provided from the controlled unit 103 according to the control provided from the user interface 101 and others. It is also possible that only one of the output from the control information sending means 106 and the output from the controlled device 103 is displayed.

The controlled device 103 includes control information input means 108 for inputting control information provided from the IEEE 1394 bus, allocation means 309 for allocating the control information provided from the control information input means 108 to each functional unit according to selection by a user, first media reproduction means 110 for reproducing a medium according to the control from the allocation-means 309, second media reproduction means 111 for reproducing a medium according to the control form the allocation means 309, and display information generation means 112 for superimposing a display on a reproduction signal provided from the first and second media reproduction means 110 and 111 according to selection information provided from the allocation means 309 and control information provided from the control information input means 108. The media information reproduction means may be a DVD drive, for example.

Because no standard for outputting DVD video signal onto IEEE 1394 buses-has been developed yet, the video signal line 105 is used in addition to the IEEE 1394. However, it may be transmitted over the IEEE 1394 once a DVD video signal format for IEEE 1394 buses is established.

A procedure for performing device control in the arrangement shown in FIG. 3 will be described below.

A procedure from bus initialization until a user selects a device (unit) to control is the same as that in the first embodiment.

A procedure performed by the selection means 313 to select an object to be controlled will be described below.

As described with respect to the first embodiment, the control device 102 reads configuration ROM (not shown) to identify the manufacturer of a device. For some devices, 64-bit identifiers called EUI (Extended Unique Identifier) 64 that can uniquely identify devices throughout the world can also be read. Upper 24 bits of an EUI 64 represent a manufacturer identifier assigned by IEEE to each manufacturer and lower 40 bits represent a unique code assigned by the manufacturer to ensure uniqueness.

Thus, the control device 102 can compare the value of an EUI 64 read from a controlled device 103 with the EUI 64 of a device having the configuration of the controlled device 103, which has been stored beforehand, to determine whether the unit to be controlled has the configuration of the controlled device 103.

If it is determined that the unit to be controlled has the configuration of the controlled device 103, the selection means 313 outputs information for generating an initial screen, which is a screen for selecting one of the first and second media reproduction means 110 and 111, as shown in FIG. 2a. This screen information is displayed on the display means 107 as shown in FIG. 2a.

In FIG. 2a, “DVD A” is highlighted to indicate the first media reproduction means 110 is selected. A user operates the user interface 101. Because the currently displayed screen has been generated by the control device 102 itself, the control device 102 determines that the operation on the user interface 101 is directed to it and does-not issue any pass-through command. The selection means 313 moves the highlight in response to an up-arrow or down-arrow key operation. When “confirmation” is selected by the user, the selection means 313 stores one of the first and second media reproduction means 110 and 111 that is currently highlighted, as the object to be controlled. Then the result of the determination is sent from the control information output means 106 through the IEEE 1394 bus 104 and the control information: input means 108 to the allocation means 309 and stored there. Thus, the functional unit to be controlled is determined and subsequently a video signal provided from the controlled device 103 is displayed on the display means 107. A subsequent operation on the user interface 101 will be sent as a pass-through command from the control information sending means 106 to the controlled device 103. In this way, the object to be controlled in the controlled device 103 is determined.

Then, the selected one of the first and second media reproduction means 110 and 111 outputs screen information for selecting a content, as shown in FIG. 9, which has been described with respect to the example of prior art. This screen information is displayed as shown in FIG. 9 on the display means 107 through the display information generation means 12. The user operates the user interface 101 to selects a content. Control information in a pass-through command sent by the control information sending means 106 is transferred to the first or second media reproduction means 110 or 111 depending on the information stored in the allocation means 309, and the content selection screen information is updated and a content is selected.

The pass-through command can be specified by any other device operations, besides the GUI operation. If a pass-through command of an operation id for specifying a device operation such as a stop and a pause is sent to the controlled device 103 while a content is selected and being reproduced, it is transferred to one of the first and second media reproduction means 110 and 111 stored in the selection means 309 and the media reproduction is controlled, as with the GUI operation.

If a pass-through command of an operation id specifying a device operation is sent to the controlled device 103 before a media reproduction means is selected, a media reproduction means stored previously in the device as a default value may be selected as the item to be controlled.

If no medium is loaded in the media reproduction means stored in the device as the default value, it may be determined whether the other media reproduction means contains a medium and, if it contains one, it may be selected as means to be controlled. The media reproduction means selected in this way is stored in the selection means 309 and becomes the means to be controlled subsequently.

If a “setup menu” in the user interface 101 is operated, the control device 102 again displays the media reproduction means selection screen shown in FIG. 2a so that a functional unit to be controlled can be readily changed.

While the IEEE 1394 digital interface is used in this embodiment, any other digital interfaces can be used. For example, the embodiment can be applied to device control using Bluetooth.

According to the second embodiment as described above, the control device has the selection means allowing a user to select a functional unit to be controlled by using the display means. The user selects a functional unit to be controlled and the result of the selection is stored in the controlled unit. Thus, the second embodiment provides the advantage that a command specifying no functional unit that actually performs an operation in the controlled device can be used and yet the command can be applied to a functional unit intended by the user.

Third Embodiment

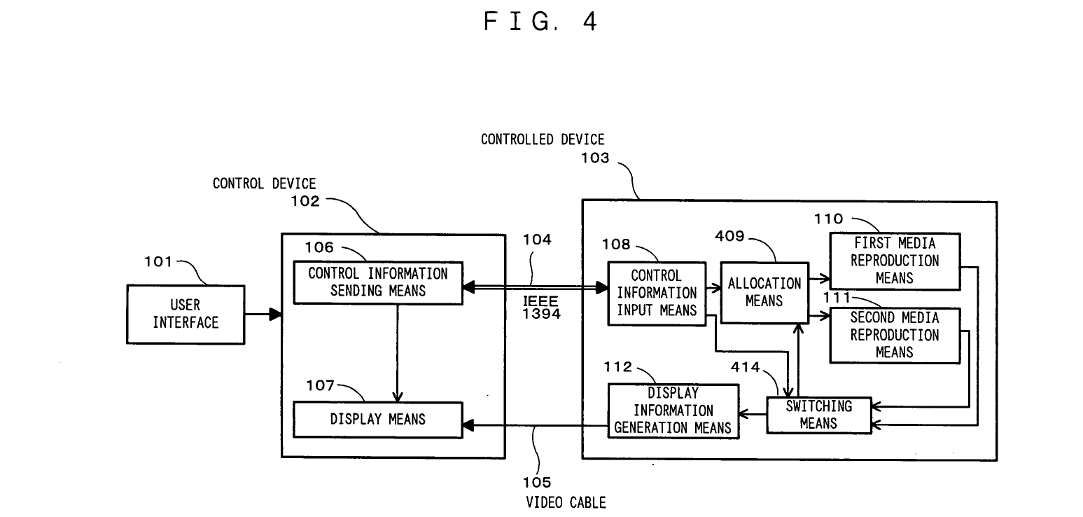

FIGS. 4 and 5 show a third embodiment. The same elements as those in FIG. 1 are labeled with the same numbers and will be described using those same numbers.

It is assumed that an IEEE 1394 interface is used and a pass-through command is used for device control.

Reference number 101 indicates a user interface, which may be a remote controller or control panel of a device, for example, Reference number 102 indicates a control device, 103 indicates a controlled device, 104 indicates an IEEE 1394 bus interconnecting the control device 102 and the controlled device 103, and 105 indicates a video signal line for transmitting a video signal from the controlled device 103 to the control device 102.

The control device 102 includes control information sending means 106 for providing control information onto the IEEE 1394 bus 104 according to a signal provided from the user interface 101 and display means 107 for displaying video signals provided from the controlled device 103 and the control information sending means 106. The information from the control information sending means 106 may be superimposed as text or a GUI on the video signal provided from the controlled device 103 or one of the information and the video signal may be displayed, depending on control form the user interface 101.

The controlled device 103 includes control information input means 108 for inputting control information from the IEEE 1394 bus, allocation means for allocating the control information inputted from the control information input means 107 to each functional unit according to control information provided from switching means 414, a first media reproduction means 110 for reproducing a medium according to the control from the allocation means 409, a second media reproduction means 111 for reproducing a medium according to the control form the allocation means 409, the switching means 414 for switching between reproduction signals-provided from the first and second media reproduction means 110 and 111 according to the control information provided from the control information input means 108, and display information generation means 112 for outputting a signal provided from the switching means 414 as a video signal. The media information reproduction means may be a DVD drive, for example.

Because no standard for outputting DVD video signal onto IEEE 1394 buses has been developed yet, the video signal line 105 is used in addition to the IEEE 1394. However, it may be transmitted over the IEEE 1394 once a DVD video signal format for IEEE 1394 buses is established.

A procedure for performing device control in the arrangement shown in FIG. 4 will be described below;

A procedure from bus initialization until a user selects a device (unit) to control is the same as that in the first embodiment.

A procedure performed by the switching means 414 to switch between output signals from the first and second media reproduction means 110 and 111 will be described below.

The switching means 414 selects an output signal, which is a default value, immediately after the controlled device 103 is turned on. One of the first and second media reproduction means may be predefined as a default, or a media reproduction means previously used and stored may be selected as the default.

When the output of the first media reproduction means or the output of the second media reproduction means is selected-as the output of the controlled device 103 through the control device 102, a CONNECT command is issued from the control device 102. The CONNECT command is defined in AV/C General as a command for controlling plug connection of a subunit and unit. A plug herein refers to a virtual signal terminal defined in IEEE 1394. Each of the first and second media reproduction means 110 and 111 has one source plug and outputs a signal through the plug. The controlled device 103 has one external output plug and outputs a video signal to an external destination. FIG. 5 shows a format of the CONNECT command. In FIG. 5, operand [1] and operand [2] indicate signal sources and [3] and [4] indicate destinations. Source_subunit_type combined with source_subunit_ID fields specifies a subunit as a signal source. Source_plug field specifies the number of a plug. Similarly, a combination of destination_subunit_type field and destination_subunit_ID field specifies a subunit as a destination destination_plug field specifies the number of a plug. If “IF” is contained in the subunit_type field, it indicates a unit and can specify a plug, that is, an external output plug of the unit. “3F” in operand [0.0] indicates a fixed value (all bits are 1). If 1 is contained in a lock field, controlled device 103 rejects any CONNECT command that breaks a stream between plugs specified by operands [1] through [4].

Thus, the connect command allows the switching means 414 to select between signals from the first and second media reproduction means to output a selected signal to an external destination.

Information indicating which signal is selected by the switching means 414 is provided to the allocation means 409. The allocation means 409 selects media reproduction means outputting the selected signal as the element to be controlled.

The selected one of the first media reproduction means 110 or the second media reproduction mean sill outputs screen information for selecting a content, as described with respect to the example of prior art and shown in FIG. 9. The screen information is presented on the display means 107 through the display information generation means 112, as shown in FIG. 9. The user operates the user interface 101 to select a content. Control information in a pass-through command issued by the control information sending means 106 is transferred by the allocation means 409 to either the first media reproduction means 110 or the second media reproduction means 111, the content selection screen is updated and a content is selected.

The pass-through command can be specified by any other device operations, besides the GUI operation. If a pass-through command of an operation id for specifying a device operation such as a stop or a pause is sent to the controlled device 103 while a content is selected and is being reproduced, it is transferred to one of the first and second media reproduction means 110 and 111 stored in the allocation means 409 and the media reproduction is controlled, as with the GUI operation.

While a functional unit outputting a signal is controlled in this embodiment, a functional unit inputting a signal in a recording device can also be controlled.

If no medium is loaded in media reproduction means that is stored in the controlled devices as a default and outputs a signal to an external destination, it may be determined whether another media reproduction means contains a medium and, if it contains one, that media reproduction means may be selected as the object to be controlled.

According to the third embodiment as described above, the control device controls a functional unit selected by the user as a signal source. Thus, the third embodiment provides the advantage that a command specifying no functional unit that actually operates in the controlled device can be used and yet the command can be applied to a functional unit intended by the user.

A functional unit is selected on an instruction from the control device 102 in the third embodiment. However, if switching means is provided in the controlled device 103, a functional unit may be selected on an instruction from the switching means in the controlled device 103, rather than a instruction from the control device 102.

While reproduction outputs from the first and second media reproduction means 110 and 111 are provided to the control device 102 through the switching means 414 in this embodiment, an arrangement may be possible in which the reproduction outputs are provided to a device other than the control device 102 through the switching means-414.

While the IEEE 1394 digital interface is used in this embodiment, any other digital interfaces can be used. For example, the embodiment can be applied to device control using Bluetooth.

According to the present invention, the controlled device has a selection means allowing a user to select a functional unit to be controlled, the user-selects the functional unit to be controlled, and the selection is stored. Thus, the present invention provides the advantage that a command specifying no functional unit that actually operates in the controlled device can be used and yet the command can be applied to a functional unit intended by the user.

According to the present invention, the control device has the selection means allowing a user to select a functional unit to be controlled. The user selects a functional unit to be controlled and the result of the selection is stored in the controlled unit. Thus, the present invention provides the advantage that a command specifying no functional unit that actually operates in the controlled device can be used and yet the command can be applied to a functional unit intended by the user.

According to the present invention, the control device controls a functional unit selected by the user as a signal source. Thus, the present invention provide the advantage that a command specifying no functional unit that actually operates in the controlled device can be used and yet the command can be applied to a functional unit intended by the user.

1. A controlled device containing a plurality of functional units and connected in use to a control device through a digital interface of a network, wherein
said controlled device comprises selection means for selecting a functional unit to be controlled based on an instruction from said control device, storing what is selected therein, and determining the stored functional unit as an object to be controlled in response to detecting reception of a control command including no information specifying an object to be controlled from said control device.

2. The controlled device according to claim 1, wherein said selection means is arranged so as to select a functional unit to be controlled based on an instruction from said control device and store therein what is selected when no functional unit is determined to be controlled.

3. The controlled device according to claim 1, wherein said selection means detects a reception of a control command including no information specifying which functional unit is to be controlled and selects a functional unit stored as a default value when no functional unit is determined to be controlled.

4. A control device connected through a digital interface of a network to a controlled device containing a plurality of functional units, wherein
said control device comprises selection means for allowing a user to select a functional unit to be controlled, causing a selection result to be stored in said controlled device, and sending a control command including no information specifying which functional unit in said controlled device is to be controlled.

5. A controlled device containing a plurality of functional units and being connected in use to the control device as set forth in claim 4 through a digital interface of a network, wherein
said controlled device comprises allocation means for storing a result of the selection of a functional unit to be controlled, said result being sent from said control device, and, in response to detecting reception of a control command including no information specifying which functional unit is to be controlled, determining said selected-functional unit as an object to be controlled.

6. A controlled device containing a plurality of functional unit and connected in use to a control device through a digital interface of a network, wherein
said controlled device comprises:
switching means for selecting a functional unit to be controlled, storing what is selected, and outputting an output signal of the selected functional unit; and
allocation means for allocating a instruction from said control device to said plurality of functional units, and, in response to detecting reception of a control command including no information specifying which functional unit is to be controlled, causing the received command to be applied to the functional unit from which said switching means is outputting the output signal.

7. The controlled device according to any one of claims 1, 2, 3, 5 and 6, wherein said digital interface is an IEEE 1394 or Bluetooth interface.

8. The control device according to claim 4, wherein said digital interface is an IEEE 1394 or Bluetooth interface.

9. The controlled device according to any one of claims 1, 3, 5 and 6, wherein the control command including no information specifying which functional unit is to be controlled is a pass-through command.

10. The control device according to claim 4, wherein the control command including no information specifying which functional unit is to be controlled is a pass-through command.

11. A method for controlling a controlled device containing a plurality of functional units and connected in use to a control device through a digital interface of a network, wherein said method comprises the steps of:
selecting a functional, unit to be controlled based on an instruction from said control device, and storing what is selected in selection means; and
in response to detecting reception of a control command containing no information specifying an object to be controlled from said control device, the stored functional unit is determined as an object to be controlled.

12. The method for controlling the controlled device according to claim 11, wherein a functional unit to be controlled is selected based on an instruction from said control device and what is selected is stored in the selection means when no functional unit is determined to be controlled.

13. The method for controlling the controlled device according to claim 11, wherein in response to detecting the reception of a control command including no information specifying which functional unit is to be controlled, a functional unit stored as a default value is determined as an object to be controlled when no functional unit is determined to be controlled.

14. A method for controlling a control device connected to a controlled device containing a plurality of functional units through a digital interface of a network, wherein the method comprises the steps of:
allowing a user to select a functional unit to be controlled;
causing said controlled device to store a result of the selection; and
sending a control command including no information specifying which control unit in said controlled unit is to be controlled.

15. A method for controlling the controlled device containing a plurality of functional units and being connected in use to the control device as set forth in claim 14 through a digital interface of a network, wherein said method comprises the steps of:
storing a result of selection of a functional unit to be controlled, said result being sent form said control device; and
in response to detecting reception of a control command including no information specifying which functional unit is to be controlled, determining said selected functional unit as an object to be controlled.

16. A method for controlling a controlled device containing a plurality of functional units and connected in use to a control device through a digital interface of a network, wherein said method comprises the steps of:
outputting by switching means an output signal of a functional unit selected and stored as an object to be controlled;
allocating instructions from said control device to said plurality of functional units; and,
in response to detecting reception of a control command including no information specifying which functional unit is to be controlled, applying the received command to the functional unit from which said switching means is outputting the output signal.

17. The method for controlling the controlled device according anyone of claims 11, 12, 13, 15 and 16, wherein said digital interface is an IEEE 1394 or Bluetooth interface.

18. The method for controlling the control device according to claim 14, wherein said digital interface is an IEEE 1394 or Bluetooth interface.

19. The method for controlling the controlled device according to any one of claims 11, 13, 15, and 16, wherein said control command including no information specifying which functional unit is to be controlled is a pass-through command.

20. The method for controlling control device according to claim 14, wherein said control command including no information specifying which functional unit is to be controlled is a pass-through command.
